(19) United States
(12) Patent Application Publication
(10) Pub. No.: US 2004/0129297 A1
(43) Pub. Date: Jul. 8, 2004

(54) Method and system for reducing effects of halfpitch wafer spacing during wet processes

(76) Inventor: Kenneth T. Settlemyer JR., Poughquag, NY (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/337,013

(22) Filed: Jan. 3, 2003

(51) Int. Cl. B08B 9/20

(52) U.S. Cl. 134/25.4; 134/42; 134/133; 134/137; 134/201; 134/902; 414/222.01

(57) ABSTRACT

A system for processing wafers is disclosed. In the invention, a tank contains a processing liquid. A movable submersion mechanism is positioned to move in and out of the tank. Wafer holders in the submersion mechanism have an unequal spacing within the submersion mechanism.

### BACKGROUND OF THE INVENTION

1. Field of the Invention

The present invention generally relates to semiconductor wafer processing and more particularly to improved systems/methods that increases the effectiveness of liquid based processing.

2. Description of the Related Art

A common method of reducing the footprint and chemical/water consumption of wet process tools is to interleave wafers, placing twice as many wafers in the space of a standard batch of fullpitch wafers, commonly known in the industry as halfpitch. However, halfpitch processing leads to issues in flow dynamics and the effect of capillary action, such as watermark performance, causes a reduction in the process robustness or process window.

Additionally, methods of drying present other concerns, including fluid flow in the case of spin-type processes. The alternative spacing commonly used by those skilled in the art is the typical ‘full pitch’ drying. This alternative has the significant disadvantage of doubling the amount of space needed for the wafers or only allowing smaller batches of wafers in the same size bath, both of which increase the chemical usage and rinsewater usage, or reduce the throughput of the tooling.

### SUMMARY OF THE INVENTION

The present invention provides a structure and method for an improved liquid based processing method and system. In the invention, a movable submersion mechanism is positioned to move in and out of the tank. Wafer holders in the submersion mechanism have an unequal spacing. The wafer holders are spaced to provide a larger spacing between fronts of the wafers than between backs of the wafers. The fronts of the wafers have a higher processing precision than the backs of the wafers. The first meniscus of the processing liquid along the backs of the wafers is higher than the second meniscus of the processing liquid along the fronts of the wafers. A difference between the first meniscus and the second meniscus is a result of differences in capillary interaction between different spacings between the fronts and the backs of the wafers. The submersion mechanism is adapted to interleave multiple sets of the wafers and is further movable to load multiple sets of the wafers from multiple locations.

The invention also provides a method for processing wafers that loads the first set of wafers into wafer holders within the submersion mechanism, such that every other wafer holder loads a wafer from the first set of wafers. The invention positions the submersion mechanism over a second set of wafers. Next, the invention rotates the second set of wafers, such that the second set of wafers are aligned with and positioned in an opposite direction to the first set of wafers. The invention loads the second set of wafers into remaining wafer holders within the submersion mechanism, such that the first set of wafers are in a face-to-face and back-to-back relationship to the second set of wafers. Every other wafer holder that did not grasp the first wafers is used to grasp the second wafers. The wafer holders are spaced to provide a larger spacing between fronts of the wafers than between backs of the wafers. The invention submerges the submersion mechanism and the wafers in a processing liquid. The invention performs submerged processing on the wafers and removes the wafers from the processing liquid. During the submerged processing and the removing process, a first meniscus of the processing liquid along the backs of the wafers is higher than a second meniscus of the processing liquid along the fronts of the wafers. The submersion mechanism is adapted to interleave multiple sets of the wafers.

As discussed above, the invention allows the pitch to be reduced for wet processing. More specifically, the invention increases the spacing between the fronts of the wafers by decreasing the spacing between the backs of the wafers. This reduces the meniscus along the fronts of the wafers and permits the contamination of the fronts of the wafers to be decrease for a given size pitch. Alternatively, this permits the pitch to be decreased while maintaining the same contamination level. Therefore, the invention decreases contamination and/or allows the pitch to be decreased, when compared to systems that provide a 50/50 spacing, by increasing the spacing between the fronts of the wafers above 50/50 and decreasing the spacing between the backs of the wafers below 50/50.

The invention described below utilizes an improved method and system of placing the wafers in a reduced volume format equivalent to that obtained with standard halfpitch spacing, while lessening the effects of halfpitch spacing to improve process robustness and the window of capability. Although this invention is beneficial to drying with a marangoni type of drying process or other meniscus based drying, it will also show usefulness in other methods of drying such as spin drying or IPA vapor drying for the same or similar reasons identified in this disclosure.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a schematic diagram of a system for loading sets of wafers from different locations and immersing the wafers and a processing liquid;

FIG. 2 is a schematic diagram of a portion of a wafer partially submerged in a processing liquid;

FIG. 3 is a schematic diagram of the interaction of a processing liquid between two wafers;

FIG. 4 is a schematic diagram of the interaction of a processing liquid between two wafers;

FIG. 5 is a schematic diagram of the interaction of a processing liquid between a series of equally spaced wafers;

FIG. 6 is a schematic diagram of the interaction of a processing liquid between a series of unequally spaced wafers;

FIG. 7 is a schematic diagram of a loading mechanism according to the invention; and

FIG. 8 is a flow diagram illustrating a preferred method of the invention.

### DETAILED DESCRIPTION OF PREFERRED EMBODIMENTS OF THE INVENTION

As discussed above, as the pitch of wafers in liquid processing is decreased, a larger number of wafers can be processed in each liquid processing tool. This reduces the number of machines required (decreasing floor space requirements) and decreases the volume of liquid chemicals needed for a given number of wafers. However, as the pitch is decreased, more liquid chemicals (and other associated particulate) remain upon the wafers because of capillary and other similar effects. More specifically, as wafers are placed in closer proximity, they tend to increase capillary action of the liquid, which reduces the ability of the liquid to drain from the wafer surface and increases deposits on the wafer surface after it is removed from the liquid chemical.

The invention addresses this problem by increasing the spacing between the faces of adjacent wafers and, at the same time decreasing the spacing between the backs of the adjacent wafers. For purposes of this invention, the “face” of a wafer is the surface upon which the various circuits will be developed, while the “back” of the wafer is the opposite side that will not receive substantial (tolerance critical) processing. In other words, the front of the wafers is subject to a higher processing precision than the backs of the wafers and it is more important that the front side be free of foreign matter.

The container the wafers are kept in is commonly known as the boat. The structure the wafers rests on in the process tool (or grasped by) is known by many names depending on the manufacturer, but may or may not contain movable parts (grippers usually move in relation to the wafer, lifters or boats move up and down with the wafers in them). This invention works with all setups listed above as well as other similar setups.

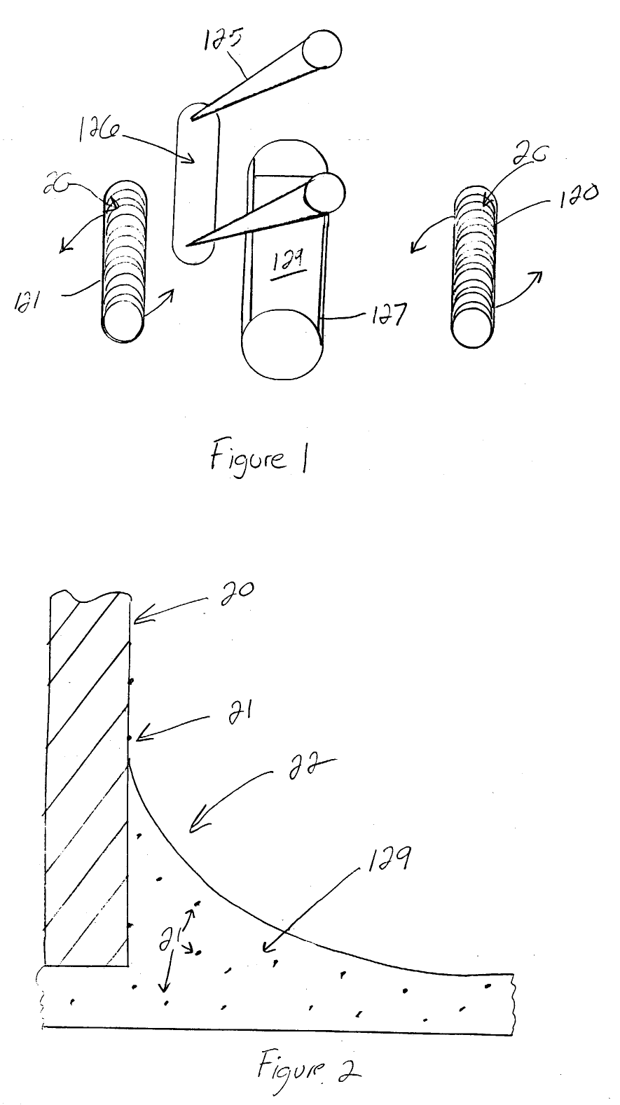

Equal halfpitch spacing between semiconductor wafers, is defined here as a 50/50 ratio between wafers. The spacing is typically done by interleaving two 25 wafer batches. This can be done so that either they all face the same way (face-to-back), or so that one batch is turned to face the other batch and is then interleaved so that the front of each wafer is facing the front of another wafer (face-to-face). FIG. 1 illustrates a device that can interleave wafers.

More specifically, FIG. 1 is a schematic diagram of a device that includes a movable assembly 125 that includes a boat (holding/submersion mechanism) 126 that has the ability to hold or grasp wafers 20 transferred from trays 120, 121 (boats). The wafers are positioned in wafer holders (slots, clamps, grooves, etc.) in the holding mechanism 126. The holding trays 120, 121 can be rotated as indicated by the arrows in FIG. 1. The assembly 125 moves the holding mechanism 126 over one of the trays 121 and loads the wafers 20 from that tray 121. The mechanism 125 then swings the holding mechanism 126 over another tray 120 and loads the wafers 20 therefrom. The holding mechanism 126 and wafers are submerged in a tank 127 containing processing liquid 129 (e.g., chemicals, etc. used to clean, etch, etc. the wafers), rinse water, or a drying process of a variety of types as commonly known to those skilled in the art. The holding mechanism 126 includes one or more bottom openings through which the processing liquid 129 can easily enter and exit the holding mechanism 126.

In this manner, the mechanism provides the ability to interleave the wafers from the different trays. Further, the invention provides the ability to rotate one of the trays 120, 121 such that the interleaved wafers alternately face in opposite directions. In doing so, this structure provides the ability for the face of each wafer to be opposite the face of an adjacent and for the back of each wafer to the opposite the back of each adjacent wafer (except for the wafers at the very end). Typically, the side of the wafers that are not facing another wafer would be the backside of the wafer, not the front side, as the flow dynamics of an unconstrained wafer is significantly different than the rest of the wafers, which is undesirable. The structure shown in FIG. 1 is merely exemplary and many different structures could accomplish the same purpose of interleaving the wafers from the different trays 120, 121. With the structure shown in FIG. 1, the pitch of the wafers held by the holding mechanism 126 is decreased to less than the pitch within each of the trays 120, 121.

The starting pitch of a single batch of substrates is representative of the standard pitch defined by industry standards. Note that in non-semiconductor applications this technique could also be applied, where the standard pitch is different than that within semiconductor processing). Many processing steps in semiconductor processing are single wafers, and wafer handlers are designed based on this standard pitch. Also, single wafer processors do not have any need for specific pitch in relation to the process so it is left at industry standard for the boats.

FIG. 2 is a closeup illustration of portion of a wafer 20 partially submerged within the chemical liquid 129. In FIG. 2, only the lower most portion of the wafer 20 and uppermost portion of the chemical liquid 129 is illustrated. FIG. 2 also illustrates various particles 21 within the liquid 129 and on the surface of the wafer 20. Because of surface tension, a meniscus 22 is formed. The meniscus 22 is a region where the liquid 129 remains along a portion of the wafer 20 even though that portion of the wafer 20 has been removed from the liquid 129. This is a well-known phenomenon caused by molecular surface tension (capillary action) of the liquid 129.

During a drying process, the meniscus shape controls the physical removal of water from the surface of the wafer. This meniscus is controlled in many processes of this type by extraction speed, liquid flow rate to control surface disturbances, and addition of tension altering chemistries in the liquid or on the surface of the liquid such as in the marangoni principle. It is not really the height of the meniscus per se that allows particles to remain but, rather, the angle of the edge of the meniscus with the edge of the wafer and the interaction of its movement in relation to the wafer during the drying process, or in the case of multiple bath systems during the material transfer from one bath to another. Also, with topography on the wafer, the meniscus is disturbed as the wafer passes by, and wafers spaced closely together will have more interaction. Additionally, there is an interaction of the process parameters that can cause lines of particulates, particularly with a test known as the oxide sandwich test, whereby a bare silicon wafer faces an oxide covered wafer (hydrophobic facing hydrophilic) causing a difference in surface tension/meniscus shape, showing a sensitivity to the process parameters. It has been shown that the parameter optimization of the sandwich test is counter to the optimization of the parameters for watermarks and that the spacing control widens this process window allowing both responses to be controlled to reasonable levels (zero particle addition and zero watermarks is the desired target).

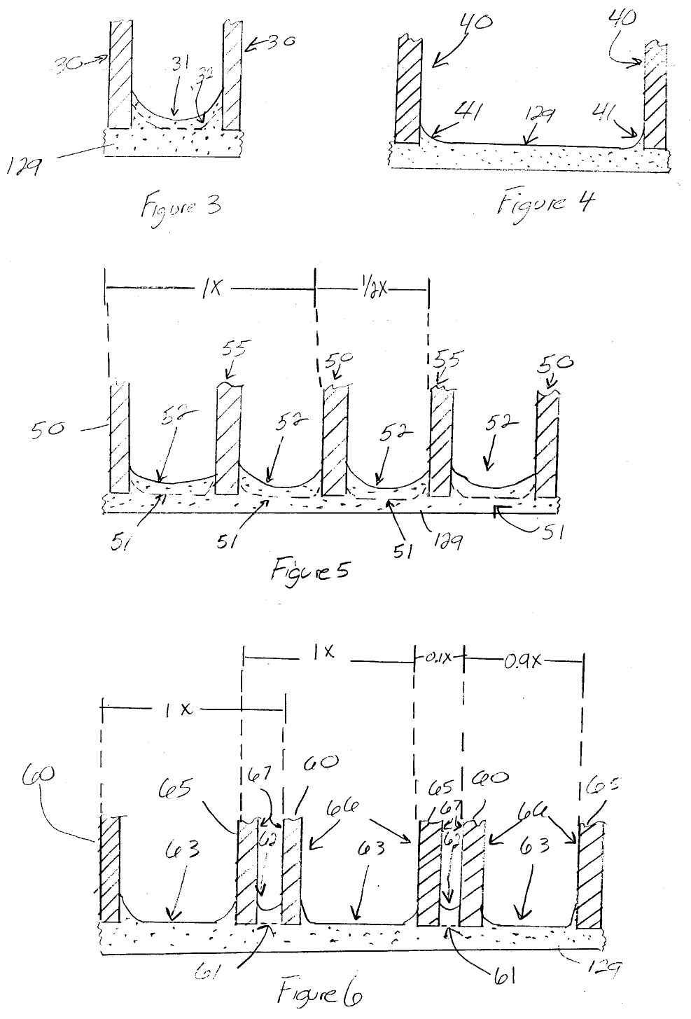

FIGS. 3 and 4 illustrate the different meniscus shapes that occur depending upon the spacing of the wafers. More specifically, in FIG. 3, two wafers 30 are very closely spaced. This causes the meniscus to rise to line 31. Line 32 represents the meniscus that would be formed along each wafer, without the presence of the adjacent wafer. To the contrary, in FIG. 4, since the wafers 40 are spaced further apart, the meniscus 41 does not rise as high. In other words, in FIG. 4, the adjacent wafers 42 not influence the shape and size of the meniscus of an adjacent wafer, while in FIG. 3 they do. FIG. 4 illustrates the ideal multiple wafer system with the meniscus producing no capillary interaction, however this case can represent very wide spacing, which, depending on the liquids and surfaces used, can be on the order of centimeters.

FIG. 5 illustrates portions of two sets of interleaved wafers 50, 55 that are partially submerged within the liquid 129. The wafers 50 are positioned at one pitch (1X) and wafers 55 are similarly positioned at the same pitch. The wafers are interleaved making the pitch between each of the wafers from the different sets (50 and 55) equal to one-half the pitch (½ X) of each of the individual wafer sets (50 or 55). The wafers are spaced equally and such spacing is referred to herein as 50/50. This represents that each of the interleaved wafers (e.g., 50) is approximately one-half way between the adjacent two wafers (e.g., 55) of the other set of interleaved wafers. In the structure with 50/50 spacing, it is irrelevant as to whether the wafers are positioned face-to-face, back-to-back, or face-to-back in the case of this invention, although there are other reasons to process preferably front-to-front which is well known to those skilled in the art. The actual measurements of the different pitches (1X, ½X, ¼X, ⅛X, etc.) will vary depending upon the molecular makeup (surface tension constant) of the liquid, the processing temperature, pressure, etc. Therefore, the actual spacings are relative to the specific processing involved.

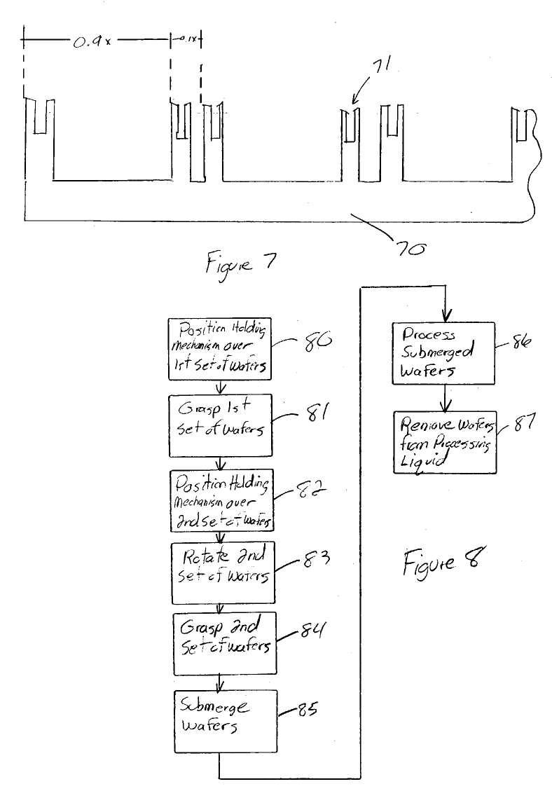

As discussed above, this represents a more efficient liquid processing system because an increased number of wafers can be processed using the same machinery and a similar volume/concentration of liquid 129. However, as with the situation shown in FIG. 3, the spacing of the interleaved wafers 50, 55 causes the meniscus 52 of the liquid 129 to rise above the level 51 that the meniscus would maintain if the wafers 50, 55 were not interleaved. Because of this increased height 52 of the meniscus, the ability to decrease the pitch between wafers in liquid processing is restricted. The invention overcomes this restriction with the structure shown in FIG. 6.

In a somewhat similar manner to the structure shown in FIG. 5, in FIG. 6 alternating sets of wafers 60, 65 are interleaved and partially submerged within the chemical processing liquid 129. Also, as with the structure shown in FIG. 5, the spacing between the wafers of one set 60 has a full pitch (1X) and the spacing between the wafers of the other set 65 also has a full pitch (1X). However, in contrast to the structure shown in FIG. 5, the backs of the wafers 67 are more closely spaced than the fronts of the wafers 66. Thus, there is a first meniscus along the backs of the wafers that is higher than a second meniscus along the fronts of the wafers. This difference between the first meniscus and the second meniscus is a result of differences in capillary interaction between the different spacings between the fronts and backs of the wafers. While this creates a large meniscus rise 62 (when compared to the unaltered meniscus level 61) between the backs 67 of the adjacent wafers, it reduces the meniscus 63 between the fronts 66 of the adjacent wafers.

As discussed above, by reducing the meniscus 63, the liquid processing produces less particle contamination upon the front surfaces 66 of the wafers. While the particle contamination of the backs 67 of the wafers is increased by this system, this does not substantially affect the quality of the wafers because the back side 67 of the wafers is not subjected to high tolerant processing. Therefore, extra contamination of the back side 67 of the wafers does not decrease yield substantially.

The example shown in FIG. 6 has a 90/10 ratio (0.1X to 0.9X ratio) of pitch spacing between the backs 67 and the fronts 66 of the interleaved sets 60, 65 of wafers. This is merely an example and the invention can be adjusted to any ratio that is slightly larger than the 50/50 ratio shown in FIG. 5. Therefore, for example, in some situations the only adjustment that may be necessary is 51/49 ratio, while the other situations a 99/1 ratio may be necessary. The significance that should be understood from the foregoing is not the specific ratio, but instead that the distance between the fronts 66 of the wafers is increased relative to the distance between the backs 67 of the wafers in order to reduce the meniscus 63 along the fronts 66 of each of the wafers. These distances and ratios will vary depending upon the various processing conditions (surface tension constant, pressure, temperature, speed of removal from the liquid, other processing gases present, flow rates of the gases, etc.).

It is desirable that the meniscus of the liquid interacting with the front of each wafer be as if each wafer did not have another wafer facing it. In practice, this may not be feasible, based on the liquid and surfaces in question, however even a slight increase in the spacing between the fronts of the wafers will improve the situation from the 50/50 spacing. This is done also with the constraint that increasing the face-to-face spacing also decreases the back-to-back spacing, ultimately allowing the wafers to be pulled together by capillary forces, or in the worst case outside the preferred range, the wafers are in direct contact regardless of process. It is also acknowledged that this meniscus is dependent on the liquid used and on the wetability of the material surface by the chosen liquid system.

FIG. 7 illustrates one example of the holding device 126 shown in FIG. 1. More specifically, among other elements, the holding device 126 would include a frame 70 and clamps 71, slots, wafer holders, etc., extending from the frame 70. The frame 70 and wafer holding devices 71 comprise any material that would be suitable for the liquid processing. Therefore, the material should not react with the chemical liquid 129 used in the wafer processing. In addition, the material should be able to withstand the various temperatures, pressures, etc. that will be seen during the liquid processing. The wafer holding devices 71 can be any type of holding mechanism including slots, grooves, physical pinching clamps, electrostatic clamps, suction clamps, pressure clamps, etc.

An important feature of the holding device shown in FIG. 7 is the spacing of the wafer holding devices 71. Consistent with the example shown in FIG. 6, the clamps have a 90/10 spacing ratio (0.9X to 0.1X). Therefore, the spacing of the wafer holding devices 71 determines the spacing of the wafers 60, 65 shown in FIG. 6. The spacing of the clamps 71 can be set to any ratio above 50/50, as discussed above with respect to the wafers 60, 65. The movement of the assembly 125 and holding mechanism 126 is adjusted so that the wafer holders 71 lineup with the wafers 20 within the trays 120, 121. The spacing of the wafer holders 71 can be fixed or adjustable. A structure with fixed spacing in the wafer holders 71 would only be useful with one spacing ratio. To the contrary, adjustable clamps could be changed to accommodate different ratios (different forms of liquid processing). The detailed workings of such an adjustment mechanism for the clamps would be well known by one ordinarily skilled in the art and are not discussed in detail herein.

FIG. 8 is a flowchart showing the processing of the invention. More specifically, in item 80, the invention moves the holding mechanism 126 over a first set of wafers. Then, in item 81, the holding mechanism grasps/loads the first set of wafers. Every other wafer holders 71 would pick up a wafer from the first set of wafers. In item 82, the holding mechanism is positioned over a second set of wafers. Before the holding mechanism 126 loads the second set of wafers, the second set of wafers is rotated (item 83) such that the second set of wafers is positioned in an opposite direction to the first set of wafers. This allows the wafers to be established in a face-to-face and back-to-back relationship when they are finally loaded by the holding mechanism 126. Item 84 represents the loading of the second set of wafers by the holding mechanism 126. More specifically, every other wafer holders 71 (that did not grasp the first wafers) are used to grasp the second wafers.

An important feature of the invention in item 84, is that the wafer holders 71 have a spacing ratio that is above 50/50, as shown in FIG. 7. This allows the spacing between the fronts of the wafers 66 to the greater than the spacing between the backs of the wafers 67 which reduces the meniscus 63 along the fronts 66 of the wafers 60, 65, as shown in FIG. 6.

The assembly 125 then moves the holding mechanism 126 to be submerged within the processing liquid 129 (item 85) that is held within the tank 127. The wafers then undergo the submerged processing (item 86) and are eventually removed from the processing liquid 129, in item 87.

As discussed above, the invention allows the pitch to be reduced for wet processing. More specifically, the invention increases the spacing between the fronts of the wafers by decreasing the spacing between the backs of the wafers. This reduces the meniscus along the fronts of the wafers and permits the contamination of the fronts of the wafers to be decrease for a given size pitch. Alternatively, this permits the pitch to be decreased while maintaining the same contamination level. Therefore, the invention decreases contamination and/or allows the pitch to be decreased, when compared to systems that provide a 50/50 spacing, by increasing the spacing between the fronts of the wafers above 50/50 and decreasing the spacing between the backs of the wafers below 50/50.

This technique lends itself very well where semiconductor wafers are being removed in a controlled manner from a processing liquid (e.g., water, etc.) as part of a drying process, perhaps with IPA (Isopropyl Alcohol) or other vapor in the gas environment above the wafer or condensed on the surface of the water as in the case of marangoni effect or surface tension gradient drying. It is also applicable as an improvement for wafer movement from tank to tank during process for the purposes of liquid removal during extraction from the process tank and front side rinsing efficiency.

Increased spacing can assist with solution penetration between wafers especially with increases in wafer diameter. However, the invention is not limited to semiconductor wafers, because with the invention fluid flow for all processes are improved between adjacent surfaces.

While the invention has been described in terms of preferred embodiments, those skilled in the art will recognize that the invention can be practiced with modification within the spirit and scope of the appended claims.

What is claimed is:

1. A system for processing wafers comprising:
a tank containing a processing liquid;
a movable submersion mechanism positioned to move in and out of said tank;
wafer holders in said submersion mechanism, wherein said wafer holders have an unequal spacing within said submersion mechanism.

2. The system in claim 1, wherein said wafer holders are spaced to provide a larger spacing between fronts of said wafers than between backs of said wafers.

3. The system in claim 2, wherein said fronts of said wafers have a higher processing precision than said backs of said wafers.

4. The system in claim 2, wherein a first meniscus of said processing liquid along said backs of said wafers is higher than a second meniscus of said processing liquid along said fronts of said wafers.

5. The system in claim 4, wherein a difference between said first meniscus and said second meniscus is a result of differences in capillary interaction between different spacings between said fronts and said backs of said wafers.

6. The system in claim 1, wherein said submersion mechanism is adapted to interleave multiple sets of said wafers.

7. The system in claim 1, wherein said submersion mechanism is further movable to load multiple sets of said wafers from multiple locations.

8. A system for processing wafers comprising:
a tank containing a processing liquid;
a movable submersion mechanism positioned to move in and out of said tank; and
wafer holders in said submersion mechanism, wherein said wafer holders are spaced within said submersion mechanism to provide a larger spacing between fronts of said wafers than between backs of said wafers.

9. The system in claim 8, wherein said fronts of said wafers have a higher processing precision than said backs of said wafers.

10. The system in claim 8, wherein a first meniscus of said processing liquid along said backs of said wafers is higher than a second meniscus of said processing liquid along said fronts of said wafers.

11. The system in claim 10, wherein a difference between said first meniscus and said second meniscus is a result of differences in capillary interaction between different spacings between said fronts and said backs of said wafers.

12. The system in claim 8, wherein said submersion mechanism is adapted to interleave multiple sets of said wafers.

13. The system in claim 8, wherein said submersion mechanism is further movable to load multiple sets of said wafers from multiple locations.

14. A submersion mechanism for processing wafers in a processing liquid, said submersion mechanism comprising:
wafer holders adapted to hold said wafers; and
wherein said wafer holders are spaced within said submersion mechanism to provide a larger spacing between fronts of said wafers than between backs of said wafers.

15. The submersion mechanism in claim 14, wherein said fronts of said wafers have a higher processing precision than said backs of said wafers.

16. The submersion mechanism in claim 15, wherein a first meniscus of said processing liquid along said backs of said wafers is higher than a second meniscus of said processing liquid along said fronts of said wafers.

17. The submersion mechanism in claim 16, wherein a difference between said first meniscus and said second meniscus is a result of differences in capillary interaction between different spacings between said fronts and said backs of said wafers.

18. The submersion mechanism in claim 14, wherein said clamp is adapted to interleave multiple sets of said wafers.

19. A method for processing wafers comprising:
positioning a submersion mechanism over a first set of wafers;
loading said first set of wafers into wafer holders within said submersion mechanism, such that every other wafer holder loads a wafer from said first set of wafers;
positioning said submersion mechanism over a second set of wafers;
rotating said second set of wafers, such that said second set of wafers is aligned with and positioned in an opposite direction to said first set of wafers;
loading said second set of wafers into remaining wafer holders within said submersion mechanism, such that said first set of wafers are in a face-to-face and back-to-back relationship to said set of wafers, wherein every other wafer holder that did not grasp said first wafers is used to grasp said second wafers, and wherein said wafer holders are spaced to provide a larger spacing between fronts of said wafers than between backs of said wafers;
submerging said submersion mechanism and said wafers in a processing liquid;
performing submerged processing on said wafers; and
removing said wafers from said processing liquid.

20. The method in claim 19, wherein said fronts of said wafers have a higher processing precision than said backs of said wafers.
